(19) United States
(12) Patent Application Publication
(10) Pub. No.: US 2024/0381461 A1
(43) Pub. Date: Nov. 14, 2024

(54) SYSTEM AND METHOD FOR APPLIANCE COMMUNICATION

(71) Applicant: Haier US Appliance Solutions, Inc., Wilmington, DE (US)

(72) Inventors: Aaron Lee Welch, Louisville, KY (US); Nicholas Matthew Dillon, Louisville, KY (US); Jason Fuchs, Louisville, KY (US); David Zhou, Raleigh, NC (US)

(21) Appl. No.: 18/316,542

(22) Filed: May 12, 2023

(51) Int. Cl. H04W 76/15; H04W 60/04

(52) U.S. Cl. CPC H04W 76/15; H04W 60/04

(57) ABSTRACT

A system and method for appliance communication is provided. The method includes connecting an initially-connected device to a server via a network; initiating, at a first appliance, a first appliance registration process; detecting, via the first appliance, a communications signal from a second appliance; communicatively coupling the second appliance to the server via the initially-connected device; and transmitting second appliance registration data from the second appliance to the server via communicative coupling of the second appliance to the initially-connected device connected to the network.

### FIELD

The present subject matter relates generally to consumer or commercial appliances, such as domestic appliances, and more particularly to systems and methods for appliance communication.

### BACKGROUND

Various household and commercial appliances are internet-connectable, allowing for data from the appliance to be sent from the appliance. However, various appliances may include different user interfaces, which may inhibit a user from connecting appliances to a network and allowing data to be sent from the appliance, which may further inhibit an appliance from receiving software updates, improving control routines, or sending and receiving data that may allow for further appliance features. Barriers to activating such features may result in appliance under-performance and reduced efficiency.

Accordingly, improved systems and methods for appliance communication that address the aforementioned issues would be beneficial and advantageous.

### BRIEF DESCRIPTION

Aspects and advantages of the invention will be set forth in part in the following description, or may be obvious from the description, or may be learned through practice of the invention.

An aspect of the present disclosure is directed to a computer-implemented method for appliance communication. The method includes connecting an initially-connected device to a server via a network; initiating, at a first appliance, a first appliance registration process; detecting, via the initially-connected device, a communications signal from a second appliance; communicatively coupling the second appliance to the server via the initially-connected device; and transmitting second appliance registration data from the second appliance to the server via communicative coupling of the second appliance to the initially-connected device connected to the network.

Another aspect of the present disclosure is directed to an appliance including a controller operably coupled to a wireless communications device. The controller is configured to execute instructions that causes the appliance to perform operations. The operations include connecting the appliance to a server via a network; initiating a first appliance registration process; detecting a communications signal from a second appliance; connecting the second appliance to the server via communicative coupling to the second appliance; and transmitting second appliance registration data from the second appliance to the server via communicative coupling to the second appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1A provides a schematic diagram of a communication network for a plurality of appliances in accordance with aspects of the present disclosure.

FIG. 1B provides a schematic diagram of a communication network for a plurality of appliances in accordance with aspects of the present disclosure.

FIG. 2A provides a schematic diagram of a communication network for a plurality of appliances in accordance with aspects of the present disclosure.

FIG. 2B provides a schematic diagram of a communication network for a plurality of appliances in accordance with aspects of the present disclosure.

FIG. 3 provides an exemplary schematic flowchart in accordance with aspects of the present disclosure.

FIG. 4 provides a flowchart outlining exemplary steps of a method for appliance communication in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

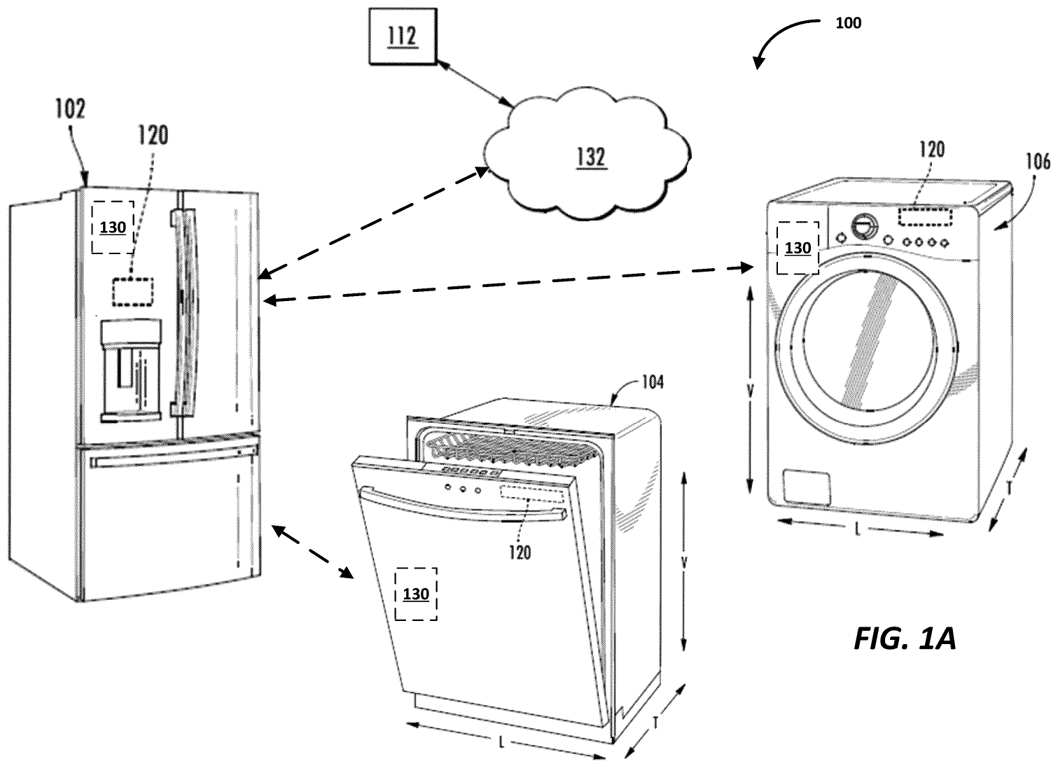

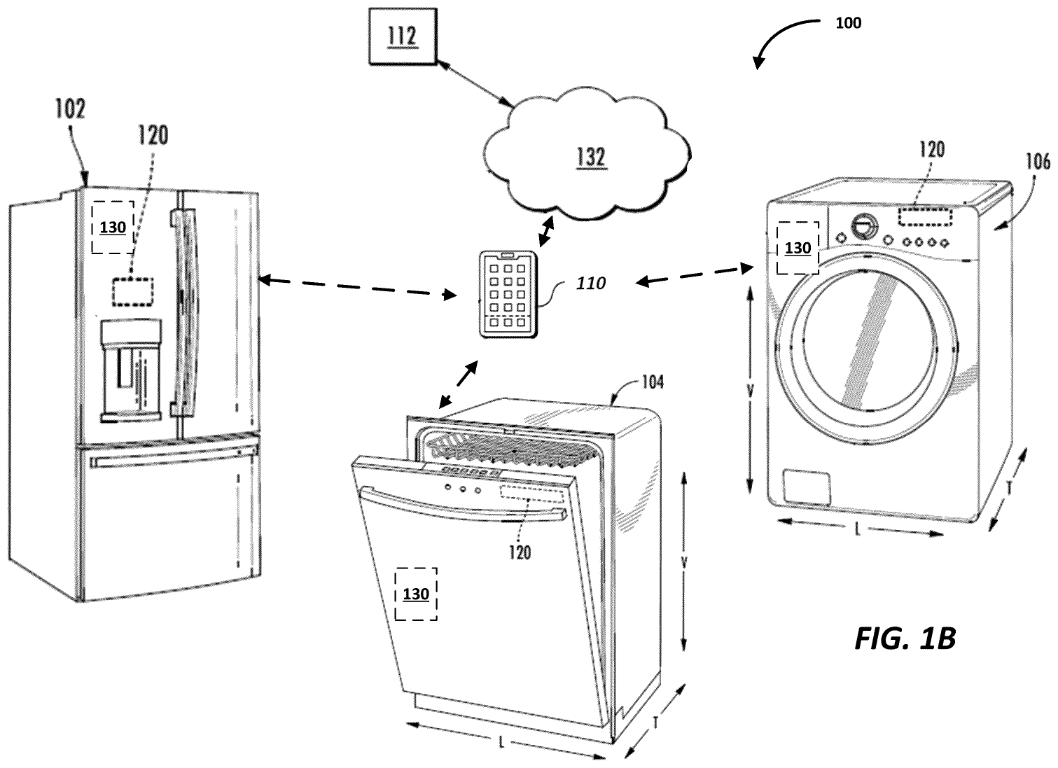

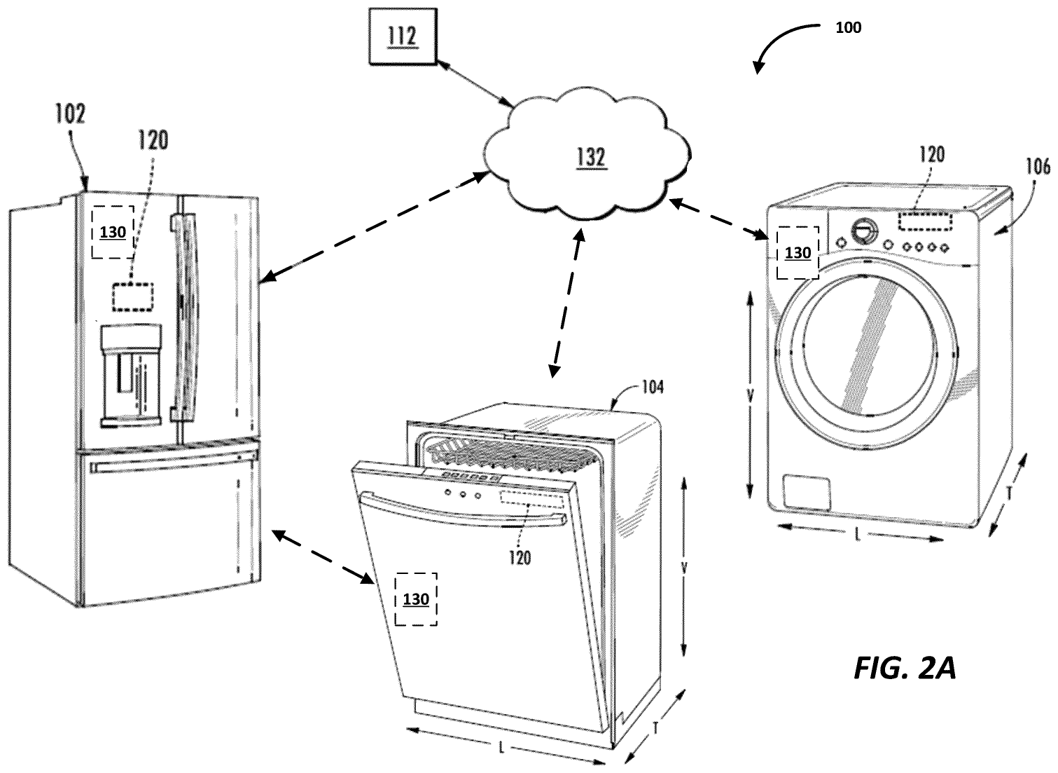

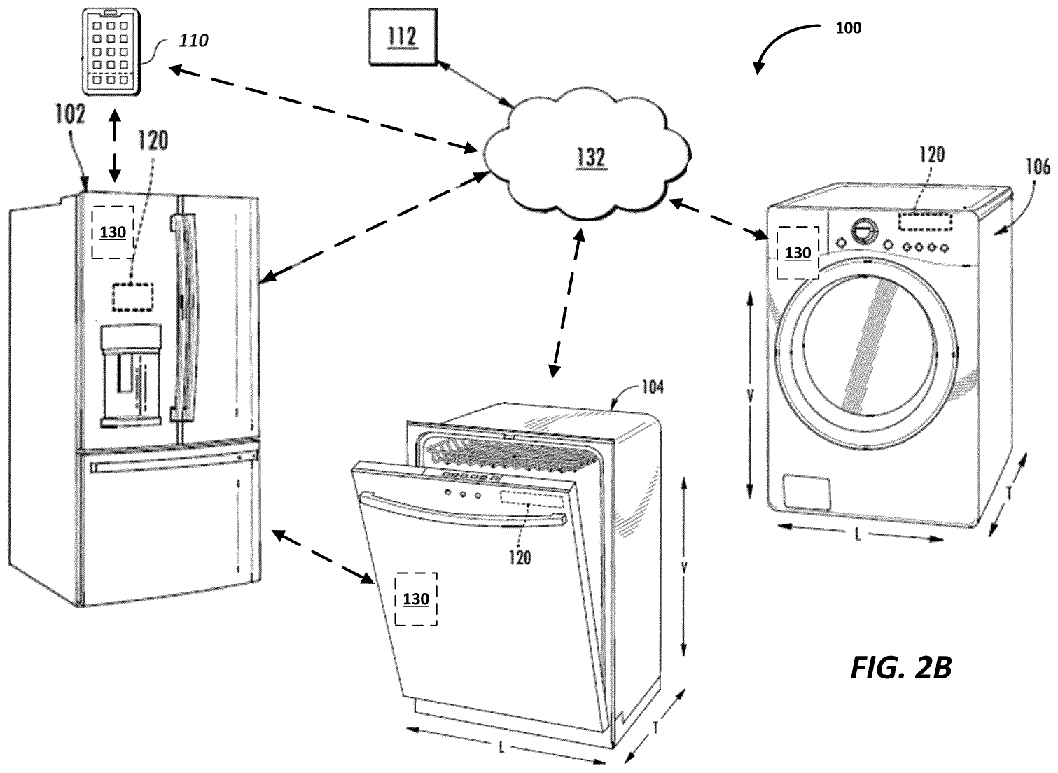

Referring now to FIGS. 1A-1B and FIGS. 2A-2B, exemplary schematic diagrams of a communication network for a plurality of appliances in accordance with aspects of the present disclosure is provided (hereinafter, “network 100”). In general, system 100 may include any suitable number, type, and configuration of appliances, remote servers, network devices, and/or other external devices. System 100 may include a plurality of appliances 102, 104, 106. As shown, system 100 generally includes a first appliance 102, a second appliance 104, a third appliance 106, etc., to an Nth appliance. The first appliance 102 is generally depicted as a refrigerator appliance. The second appliance 104 is generally depicted as a dishwashing appliance. The third appliance 106 is generally depicted as a laundry washing and/or drying appliance. However, it should be appreciated that the appliances 102, 104, 106 may include any type of commercial and/or household appliance (e.g., cooking appliance, cleaning appliance, beverage appliance, freezer or refrigeration appliance, air conditioning and/or heating appliance, etc.), or combinations thereof. Details regarding the operation of the appliances 102, 104, 106 may be understood by one having ordinary skill in the art and detailed discussion is omitted herein for brevity. However, it should be appreciated that the specific appliance types and configurations are only exemplary and are provided to facilitate discussion regarding the use and operation of an exemplary system 100. The scope of the present subject matter is not limited to the number, type, and configurations of appliances set forth herein.

For example, system 100 may include any suitable number and type of appliances 102, 104, 106 such as “household appliances.” These terms are used herein to describe appliances typically used or intended for common domestic tasks, e.g., such as the appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions. Moreover, although only three appliances are illustrated, various embodiments of the present subject matter may also include another number of appliances, each of which may generate and store data.

In some embodiments, such as depicted in FIG. 1B and FIG. 2B, it should be appreciated that system 100 may include one or more remote user interface devices or external computing devices 110. For instance, device 110 may include a smartphone, a tablet computing device, a personal or mobile computing device, a wearable computing device (e.g., a smart watch, smart glasses, etc.), or other type of computing device or user interface. Device 110 may include computing devices having one or more processors, memory devices, communications devices, circuitry, etc. separate from or external to the one or more appliances 102, 104, 106 and may be configured for facilitating communications with appliances 102, 104, 106 or other devices. For example, the system 100 may include or be communicatively coupled with device 110 to allow user interaction with some or all appliances 102, 104, 106, remote server 112, network 132, or other devices in the system 100.

As will be described in more detail below, some or all of the system 100 may include or be communicatively coupled with a remote server 112 that may be in operative communication with some or all appliances 102, 104, 106 within system 100. Thus, user interface device and/or remote server 112 may refer to one or more devices that are not considered household appliances as used herein. In addition, devices such as a personal computer, router, network devices, and other similar devices whose primary functions are network communication and/or data processing are not considered household appliances as used herein.

As illustrated, appliance 102, 104, 106 may include or be operably coupled to a controller, identified herein generally by reference numeral 120. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is additionally, or alternatively, configured to store, execute, or otherwise operate or perform any one or more methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. One or more database(s) can be connected to controller 120 through any suitable communication module, communication lines, or network(s).

The appliances 102, 104, 106 include a communications device 130 configured for permitting interaction, data transfer, and other communications between and among the appliance 102, 104, 106, or, additionally or alternatively, between device 110. One or more, or all, of the appliances 102, 104, 106 or device 110 may further be configured for communication with a remote server 112, such as through a computing network 132 (e.g., internet). For example, this communication may be used to transmit packets of data through the network 132 and to the remote server 112 and to receive at one or more appliances 102, 104, 106 a control routine, such as software for appliance operation, performance curves, schedules, tables, charts, operational parameters, limits, cycle settings, user notifications, etc.

Remote server 112 may be in communication with one or more appliances 102, 104, 106 or device 110 through the network 132. For instance, referring to FIG. 1A, the first appliance 102 is operably connected to the network 132, such as the Internet, to transmit/receive data packets or information, provide user inputs, receive user notifications or instructions, etc. As further described herein, second appliance 104 and third appliance 106 are communicatively coupled to the first appliance 102. Accordingly, appliances 104, 106 may be indirectly connected to the network 132 through appliance 102. In another instance, referring to FIG. 1B, device 110 is operably connected to network 132 to transmit/receive data packets or information, provide user inputs, receive user notifications or instructions, etc. Appliances 102, 104, 106 are communicatively coupled to the device 110. Accordingly, appliances 102, 104, 106 may be indirectly connected to the network 132 through device 110. In still another instance, referring to FIGS. 2A-2B, the appliances 102, 104, 106 are operably connected to the network 132, such as through an Internet connection. Remote server 112 may be a cloud-based server, and is thus located at a distant location, such as in a separate state, country, etc.

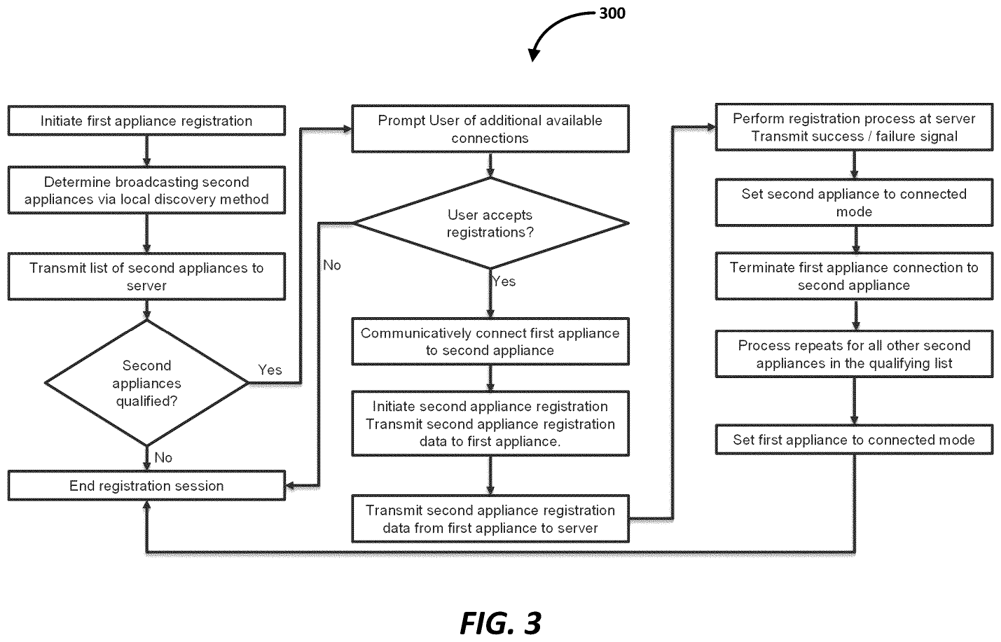

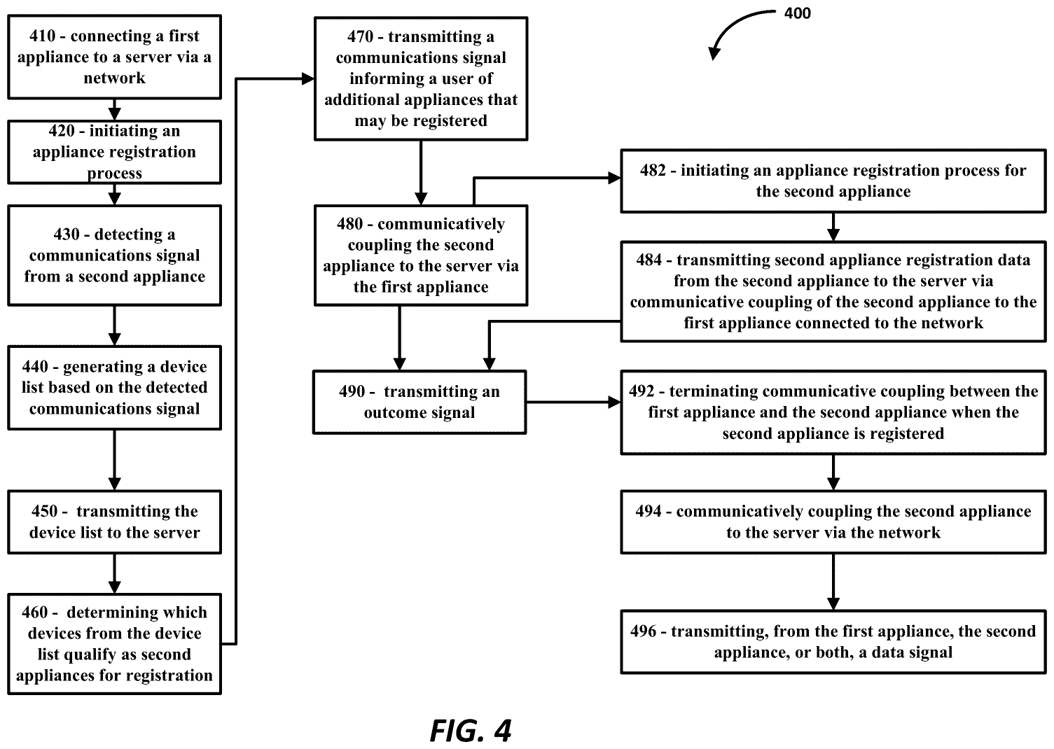

FIG. 3 provides an exemplary schematic flowchart 300 in accordance with aspects of the present disclosure. FIG. 4 provides a flowchart outlining exemplary steps of a method for appliance communication in accordance with aspects of the present disclosure (hereinafter, “method 400”). Embodiments of the flowchart 300 and method 400 may be performed and executed by embodiments of the system 100 such as depicted and described in regard to FIGS. 1A-1B and FIGS. 2A-2B. For instance, steps of the method 400 may be stored as steps, instructions, or executable routines at one or more appliances 102, 104, 106, at the server 112, or distributed among one or more appliances, servers, or connectable devices.

Exemplary embodiments include the first appliance 102 or the computing device 110 forming an initially-connected appliance or device. The method 400 includes at 410 connecting the initially-connected device (e.g., first appliance 102 or computing device 110) to a server via a network (e.g., appliance 102 or device 110 connected to network 132). For example, network 132 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP. HTTP, SMTP, FTP), encodings or formats (e.g., HTML, XML), and/or protection schemes (e.g., VPN, secure HTTP, SSL).

Method 400 includes at 420 initiating an appliance registration process, such as to transmit and/or receive data between the initially-connected device (e.g., first appliance 102 or computing device 110) and a server through the network (e.g., first appliance 102 or computing device 110 and remote server 112 through network 132). For example, method 400 at 420 includes initiating an appliance registration process for the first appliance (e.g., a first appliance registration process). Method 400 at 420 may include transmitting first appliance registration data, such as may include, but not limited to, serial numbers, appliance identifiers, configuration identifiers (e.g., specific components, or combinations thereof, at the appliance, such as manufacturer data, lot number, installation date, performance data, etc.) model numbers, usage data, performance data, operability data, service history, etc. in any appropriate data format.

Method 400 includes at 430 detecting a communications signal from a second appliance (e.g., second appliance 104, third appliance 106, Nth appliance, etc.). Method 400 at 430 may include detecting the communications signal from a plurality of devices including a second appliance (e.g., second appliance 104, third appliance 106, Nth appliance, etc.). Method 400 at 430 may include one or more local discovery processes (e.g., Wi-Fi, Bluetooth, Zigbee, near-field communications, etc.). For example, method 400 at 430 may include detecting, via the first appliance (e.g., first appliance 102), a communications signal from a plurality of devices that may include other appliances (e.g., second appliance 104, third appliance 106, etc.) within a range of the first appliance, or within range of the network (e.g., a home network, such as a LAN connection, etc.), or within range of direct communication between the first appliance and the second appliance(s).

Method 400 includes at 440 generating a device list based on the detected communications signal. The device list may include any appropriate table, chart, tabulation, sequencing, database, or other format for obtaining, sorting, or listing devices. Method 400 includes at 450 transmitting the device list to the server. An exemplary embodiment of execution of method 400 may include determining the presence of the second appliance(s) near completion of the registration process of the first appliance or after connecting the first appliance to the remote server. The method 400 may utilize any appropriate local discovery method, such as via Wi-Fi transmitter/receivers in broadcasting mode, Bluetooth pairing, Zigbee connection, etc., to collect a list of nearby devices.

Method 400 includes at 460 determining which devices from the device list qualify as second appliances for registration. Method 400 at 460 may include referencing or comparing the device list to an appliance list, such as may be securely stored on the server. The appliance list provides a list and appropriate corresponding data of appliances that qualify as second appliances (e.g., appliance models, model-types, or other identifiers of appliances). Method 400 at 460 may include comparing the device list to an appliance list to determine a second appliance list, such as appliances that may be determined to be owned, operated, possessed, or housed along with the first appliance (e.g., owned, operated, possessed, or housed by the User).

In various embodiments, method 400 includes at 470 transmitting a communications signal informing a User of additional appliances (i.e., second appliances, such as second appliance 104, third appliance 106, etc.) that may be registered. For example, method 400 at 470 may include transmitting, from the server to the first appliance, a user communications signal to a user indicative of the second appliance detected by the first appliance. In some embodiments, method 400 at 470 includes transmitting the communications signal from the server (e.g., server 112). In still some embodiments, method 400 at 470 includes transmitting the communications signal to the first appliance (e.g., first appliance 102). The User may accept the second appliance list and register one or more second appliances.

Method 400 includes at 480 communicatively coupling a second appliance (e.g., second appliance 104, third appliance 106, etc.) to the first appliance (e.g., first appliance 102). Method 400 at 480 includes communicatively coupling the second appliance to the server via communicative connection to the first appliance. Method 400 includes at 482 initiating an appliance registration process for the second appliance (e.g., a second appliance registration process). For example, method 400 at 482 includes initiating an appliance registration process for the second appliance via communicative connection of the second appliance to the server through the first appliance. Method 400 may include at 484 transmitting second appliance registration data to the server via the first appliance. For instance, method 400 at 484 includes transmitting second appliance registration data to the first appliance then transmitting second appliance registration data from the first appliance to the server. The second appliance registration data may include data such as described in regard to the first appliance registration data.

In some embodiments, method 400 includes at 490 transmitting an outcome signal. For example, method 400 may include at 490 transmitting, from the server, an outcome signal indicative of success or failure of registering the second appliance. In some embodiments, method 400 at 490 transmitting the outcome signal to the first appliance. In still some embodiments, method 400 includes at 490 transmitting the outcome signal to the second appliance.

In various embodiments, method 400 repeats the connection, registration, and transmission processes for other second appliances in the list of second appliances. Method 400 may include at 492 terminating communicative coupling between the first appliance and the second appliance when the second appliance is registered (e.g., set to a connected mode to the network). Method 400 may include at 494 communicatively coupling the second appliance to the server via the network. For example, method 400 at 494 may include a direct connection of the second appliance to the network. Method 400 may include setting the first appliance to a connected mode to the network after performing registration processes for the second appliance(s), such as after terminating communicative coupling with the second appliances.

In some embodiments, a remote device (e.g., computing device 110) may be utilized in lieu of the first appliance, such as for receiving or transmitting prompts, appliance registration data, or establishing connections. In general, communication between the appliances, remote server, and/or other user devices or appliances may be carried using any type of wireless connection and using any suitable type of communication network.

Embodiments of the method 400 may further include at 496 transmitting, from the first appliance, the second appliance, or both, a data signal. The data signal may include serial numbers, appliance identifiers, configuration identifiers (e.g., specific components, or combinations thereof, at the appliance, such as manufacturer data, lot number, installation date, performance data, etc.) model numbers, usage data, performance data, operability data, service history, etc., such as may be measured or obtained through life or usage of the appliance.

Embodiments of the system and method provided herein may overcome one or more issues described above. In various embodiments, a first appliance is configured to use local discovery processes of nearby second appliances to allow for multiple appliance registrations in a single session, such as at the first appliance (e.g., at a user interface panel or controller at the first appliance). Embodiments provided herein may overcome differences in user interfaces across various appliances, which may facilitate connecting appliances to a network, registering the appliance(s), and transmitting/receiving data between the appliance(s) and server. Improved systems and methods for appliance communication may facilitate receiving software updates at the appliance, improving appliance control routines, or sending and receiving appliance data that improve operation, efficiency, or mitigate deterioration. Accordingly, embodiments of the system 100 and method 400 provided herein may reduce or eliminate barriers to improved operation and performance of appliances.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method for appliance communication, the method comprising:
connecting an initially-connected device to a server via a network;
initiating, at a first appliance, a first appliance registration process;
detecting, via the first appliance, a communications signal from a second appliance;
communicatively coupling the second appliance to the server via the initially-connected device; and
transmitting second appliance registration data from the second appliance to the server via communicative coupling of the second appliance to the initially-connected device connected to the network.

2. The method of claim 1, wherein detecting the communications signal from the second appliance comprises:
detecting a communications signal from a plurality of devices; and
determining the second appliance from the plurality of devices.

3. The method of claim 2, wherein detecting the communications signal from the plurality of devices comprises a wireless local discovery process.

4. The method of claim 3, wherein the wireless local discovery process comprises a wireless personal area network, a local area network, a home area network, or near field communication protocol.

5. The method of claim 2, wherein determining the second appliance from the plurality of devices comprises:
generating, from the initially-connected device, a device list based on the detected communications signal from the plurality of devices;
transmitting, from the initially-connected device, the device list to the server; and
comparing, at the server, the device list to an appliance list to determine an appliance list.

6. The method of claim 5, wherein communicatively coupling the second appliance to the server via the first appliance comprises communicatively coupling the initially-connected device to the second appliance from the appliance list.

7. The method of claim 1, the method comprising:
transmitting, from the server to the first appliance, a user communications signal to a user indicative of the second appliance detected by the first appliance.

8. The method of claim 1, the method comprising:
initiating, at the initially-connected device, a second appliance registration process after communicatively coupling the second appliance to the server via the first appliance.

9. The method of claim 1, the method comprising:
terminating communicative coupling of the initially-connected device to the second appliance after transmitting second appliance registration data from the second appliance to the server; and
communicatively coupling the second appliance to the server via the network.

10. The method of claim 9, wherein communicatively coupling the second appliance to the server via the network comprises a direct connection of the second appliance to the network.

11. An appliance, the appliance comprising a controller operably coupled to a wireless communications device, the controller configured to execute instructions that causes the appliance to perform operations, the operations comprising:
connecting the appliance to a server via a network;
initiating a first appliance registration process;
detecting a communications signal from a second appliance;
connecting the second appliance to the server via communicative coupling to the second appliance; and
transmitting second appliance registration data from the second appliance to the server via communicative coupling to the second appliance.

12. The appliance of claim 11, wherein detecting the communications signal from the second appliance comprises:
detecting a communications signal from a plurality of devices; and
determining the second appliance from the plurality of devices.

13. The appliance of claim 12, wherein detecting the communications signal from the plurality of devices comprises initiating a wireless local discovery process.

14. The appliance of claim 13, wherein the wireless local discovery process comprises a wireless personal area network, a local area network, a home area network, or near field communication protocol.

15. The appliance of claim 12, wherein determining the second appliance from the plurality of devices comprises:
generating a device list based on the detected communications signal from the plurality of devices; and
transmitting the device list to the server.

16. The appliance of claim 15, wherein communicatively coupling the second appliance to the server comprises:
receiving an appliance list from the server; and
communicatively coupling the first appliance to the second appliance from the appliance list.

17. The appliance of claim 11, the operations comprising:
receiving a user communications signal indicative of detection of the second appliance.

18. The appliance of claim 11, the operations comprising:
initiating a second appliance registration process after communicatively coupling the second appliance to the server.

19. The appliance of claim 11, the operations comprising:
terminating communicative coupling to the second appliance after transmitting second appliance registration data to the server.

20. The appliance of claim 11, wherein connecting the second appliance to the server via communicative coupling to the second appliance comprises an indirect connection of the second appliance to the network through the communications device.
